(19) United States
(12) Patent Application Publication
(10) Pub. No.: US 2026/0180481 A1
(43) Pub. Date: Jun. 25, 2026

(54) MOTOR CONTROL DEVICE AND MOTOR CONTROL METHOD

(71) Applicant: Honda Motor Co., Ltd., Tokyo (JP)

(72) Inventors: Jiro FUKUI, Tokyo (JP); Kentaro YAMAGUCHI, Tokyo (JP)

(73) Assignee: Honda Motor Co., Ltd., Tokyo (JP)

(21) Appl. No.: 19/326,773

(22) Filed: Sep. 12, 2025

(30) Foreign Application Priority Data
Dec. 23, 2024 (CN) 202411902046.2

(51) Int. Cl. H02P 21/22; B60L 15/20; B60L 58/26; H01M 10/613; H01M 10/625; H01M 10/656; H02P 21/14; H02P 21/36

(52) U.S. Cl. CPC H02P 21/22; B60L 15/2045; B60L 58/26; H01M 10/613; H01M 10/625; H01M 10/656; H02P 21/14; H02P 21/36; H01M 2220/20

(57) ABSTRACT

Provided are a motor control device and a motor control method, which can prevent an unexpected torque from being generated. The control method is adapted to drive a motor having a multi-phase motor winding through vector control. The method includes that a stationary coordinate system command value is determined according to a rotating coordinate system target value; and a signal to an inverter is generated according to the stationary coordinate system command value. When a predetermined condition is satisfied, the rotating coordinate system target value is determined through converting a stationary coordinate system target value generated in a stationary coordinate system to a rotating coordinate system. When the predetermined condition is not satisfied, the rotating coordinate system target value is determined based on a target torque.

### CROSS-REFERENCE TO RELATED APPLICATION

This application claims the priority benefit of China application serial no. 202411902046.2, filed on Dec. 23, 2024. The entirety of the above-mentioned patent application is hereby incorporated by reference herein and made a part of this specification.

### BACKGROUND

### Technical Field

The disclosure relates to a control device and a method, and particularly relates to a motor control device and a motor control method.

### Related Art

In recent years, in order to ensure access to more affordable, reliable, sustainable and advanced energy for more people, research and development related to electric vehicles that contribute to energy efficiency are being conducted.

Patent Document 1 discloses an electric vehicle battery discharge device, which uses a motor and a power conversion circuit for driving as a discharge load to forcibly discharge a battery until memory effect is eliminated, thereby preventing the motor from rotating during the process of executing a complete discharge.

Patent Document 2 discloses a temperature adjustment device, which generates heat by causing loss of a motor and an inverter through generating a specified torque when the motor does not rotate. When the motor rotates, a heat more than a normal control is implemented by increasing loss through increasing a direct axis (d-axis) current in a positive direction.

FIG. 1 is a block diagram of a conventional low-efficiency operation control. Referring to FIG. 1, in the conventional process of applying a d-axis current, since there is an angle detection error Δθ between an angle (a control cognitive angle) detected by an angle sensor (a rotation transformer, etc.) and an actual rotor (MOT) angle, an energizing current I may generate a torque T due to a quadrature axis (q-axis) component caused by the angle detection error Δθ.

Therefore, in order to improve a control accuracy of the torque (current), conventionally, an external rotation suppression such as parking brakes is used to avoid an unexpected rotation of the motor (which may cause the vehicle to start moving in some conditions) when the vehicle is stopped.

### PRIOR ART DOCUMENTS

### Patent Documents

[Patent Document 1] Japanese Patent Publication No. 8-205304

[Patent Document 2] Japanese Patent Publication No. 2023-150499

### SUMMARY

In the technology related to electric vehicles, how to effectively prevent an unexpected torque from being generated is a topic for the designers in the art.

In order to solve the foregoing topic, the disclosure aims to prevent an unnecessary torque from being generated when the vehicle is stopped, thereby facilitating energy efficiency.

The disclosure provides a motor control device, which is configured to drive an inverter of a motor having a multi-phase motor winding through vector control. The motor control device comprises a control portion, which is configured to determine a stationary coordinate system command value according to a rotating coordinate system target value; and generate a signal to the inverter according to the stationary coordinate system command value. When a predetermined condition is satisfied, the rotating coordinate system target value is determined through converting a stationary coordinate system target value generated in a stationary coordinate system to a rotating coordinate system; and when the predetermined condition is not satisfied, the rotating coordinate system target value is determined based on a target torque.

In one embodiment of the disclosure, the predetermined condition includes selecting a low-efficiency operation. Current flows to a motor winding without generating a torque at a predetermined angle of the motor.

In one embodiment of the disclosure, the control portion obtains a temperature of the motor winding, and changes the stationary coordinate system target value based on the temperature of the motor winding, so that the predetermined angle of the motor is different.

In one embodiment of the disclosure, a change of an operating point of the motor winding is determined based on an allowed rotation angle of a rotor or a torque allowed to be generated.

In one embodiment of the disclosure, in a vehicle including the motor, a battery and the motor control device, the vehicle includes a rotation suppression mechanism configured to suppress a rotation of the motor. The control portion executes the low-efficiency operation when the rotation suppression mechanism is initiated.

In one embodiment of the disclosure, the motor control device further includes a temperature control circuit, which is capable of performing heat transfer between the motor and the battery. The control portion implements the low-efficiency operation based on a temperature of the battery or a temperature of a refrigerant configured to cool the battery.

The disclosure provides a motor control method, which is adapted to drive an inverter of a motor having a multi-phase motor winding through vector control. The method includes that a stationary coordinate system command value is determined according to a rotating coordinate system target value; and a signal to the inverter is generated according to the stationary coordinate system command value. The rotating coordinate system target value is determined through converting a stationary coordinate system target value generated in a stationary coordinate system to a rotating coordinate system when a predetermined condition is satisfied; and the rotating coordinate system target value is determined based on a target torque when the predetermined condition is not satisfied.

In one embodiment of the disclosure, the predetermined condition includes selecting a low-efficiency operation. Current flows to a motor winding without generating a torque at a predetermined angle of the motor.

In one embodiment of the disclosure, the method further includes that a temperature of the motor winding is obtained, and the stationary coordinate system target value is changed based on the temperature of the motor winding, so that the predetermined angle of the motor is different.

In one embodiment of the disclosure, a change of an operating point of the motor winding is determined based on an allowed rotation angle of a rotor or a torque allowed to be generated.

In one embodiment of the disclosure, in a vehicle including the motor, a battery and a motor control device, the vehicle includes a rotation suppression mechanism configured to suppress a rotation of the motor. The method further includes that the low-efficiency operation is executed when the rotation suppression mechanism is initiated.

In one embodiment of the disclosure, the method further includes that a temperature control circuit is used to perform heat transfer between the motor and the battery. The low-efficiency operation is implemented based on a temperature of the battery or a temperature of a refrigerant configured to cool the battery.

Based on the above, the motor control device of the disclosure can effectively prevent an unexpected torque from being generated through switching from a conventional rotor direct axis (d-axis) energizing manner to a current energizing manner at a stationary coordinate (that is, the motor is controlled according to a current command value in the stationary coordinate system).

In order to make the features and advantages of the disclosure more comprehensible, the following examples are given and described in detail with the accompanying drawings as follows.

### BRIEF DESCRIPTION OF THE DRAWINGS

FIG. 1 is a block diagram of a conventional low-efficiency operation control.

FIG. 2 is a functional block diagram of a motor control device 100 according to an embodiment of the disclosure.

FIG. 3A is a schematic diagram of a normal control according to an embodiment of the disclosure.

FIG. 3B is a schematic diagram of a low-efficiency operation control according to an embodiment of the disclosure.

FIG. 4 is a schematic diagram of a rotating coordinate system and a stationary coordinate system according to an embodiment of the disclosure.

FIG. 5 is a flowchart of a motor control method according to an embodiment of the disclosure.

FIG. 6 is a flowchart of a motor control method according to an embodiment of the disclosure.

FIG. 7A and FIG. 7B are comparative examples of a motor control method according to an embodiment of the disclosure.

FIG. 8A is a schematic diagram of changes of operating points of a multi-phase motor winding according to an embodiment of the disclosure.

FIG. 8B is a schematic diagram of temperature rise of a multi-phase motor winding according to an embodiment of the disclosure.

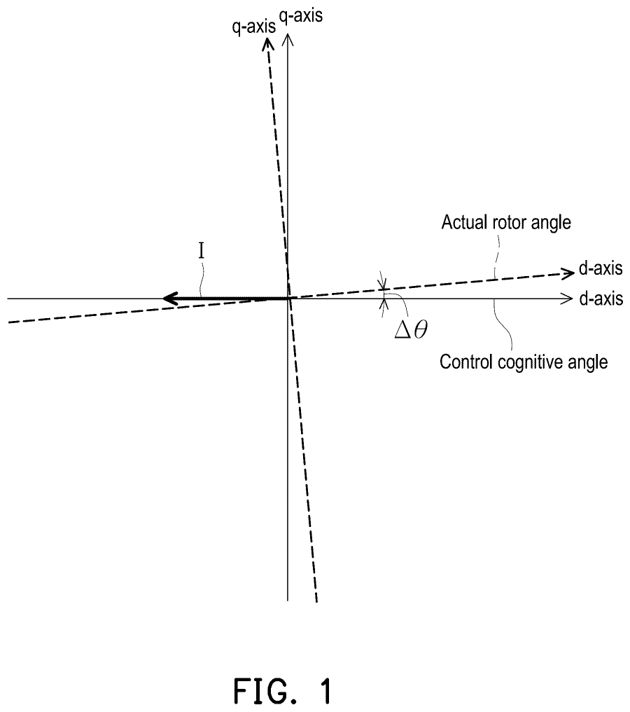

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

When a battery is charged at an extremely low temperature, a motor may stop rotating when the vehicle is stopped. Heat is generated during a non-rotating energization (a low-efficiency operation), and the battery is heated through cooling water, shortening a charging time. When the motor is energized without rotating, the embodiment of the disclosure may effectively prevent an unexpected torque from being generated through switching from a conventional rotor (MOT) direct axis (d-axis) energizing manner to a current energizing manner at a stationary coordinate, and extend an energizing time by reducing temperature rise of a rotor winding.

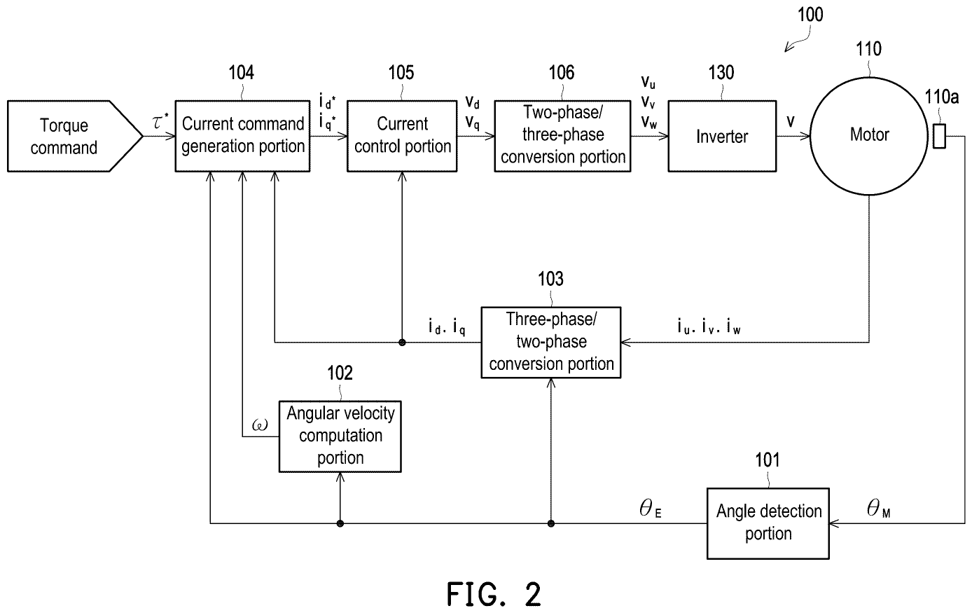

FIG. 2 is a functional block diagram of a motor control device 100 according to an embodiment of the disclosure.

As shown in FIG. 2, the motor control device 100 includes an angle detection portion 101, an angular velocity computation portion 102, a three-phase/two-phase conversion portion 103, a current command generation portion 104, a current control portion 105, and a two-phase/three-phase conversion portion 106, and is configured to drive and control a motor 110 through an inverter 130. The angle detection portion 101, the angular velocity computation portion 102, the three-phase/two-phase conversion portion 103, the current command generation portion 104, the current control portion 105, and the two-phase/three-phase conversion portion 106 serve as a control portion, which is implemented, for example, through a processor executing a program, or implemented through hardware such as large scale integration (LSI) or application specific integrated circuit (ASIC), field programmable gate array (FPGA), and may further be implemented through a combination of software and hardware, and the embodiment is not limited thereto. The motor 110 is, for example, a permanent-magnet synchronous motor (PMSM) or an interior permanent magnet synchronous motor (IPMSM), a claw-pole synchronous motor, or various other permanent magnet synchronous motors, and the embodiment is not limit thereto.

The angle detection portion 101 is configured to convert a motor angle (a mechanical angle) θ_{M} detected by an angle sensor 110a to a motor angle (an electrical angle) θ_{E}.

The angular velocity computation portion 102 is configured to differentiate the motor angle θ_{E} output from the angle detection portion 101 to compute a motor angular velocity ω.

The three-phase/two-phase conversion portion 103 is configured to perform a three-phase/two-phase conversion on three-phase currents iu, iv and iw of the motor 110 detected by a current sensor (not shown), and output a d-axis current id toward a d-axis direction and a q-axis current iq toward a q-axis direction. The current sensor is, for example, a non-contact current sensor based on the Hall effect or a contact current sensor based on the principle of generating a voltage by connecting a resistor in series to a phase line, and the embodiment is not limited thereto.

The current command generation portion 104 is configured to input a torque command value τ*, the motor angle θ_{E}, the motor angular velocity ω, the direct axis current id, and the quadrature axis current iq, and generate a dq-axes current command value serving as a current command value. Here, the current command generation portion 104 generates the dq-axes current command values id* and iq* that implement a maximum torque control.

The current control portion 105 is configured to compute a current deviation between the dq-axes current command values id* and iq* and the dq-axes currents id and iq, and then perform a proportional-integral control on each of the computed current deviations to compute dq-axes voltage command values Vd and Vq. Thus, the current control portion 105 may perform vector control based on the dq-axes current command values id* and iq*.

The two-phase/three-phase conversion portion 106 is configured to convert the two-phase voltage command values Vd and Vq to three-phase voltage command values Vu, Vv and Vw, and output to the inverter 130.

The inverter 130 is configured to turn on/off a switching element that composes the inverter 130 based on a PWM signal generated by the voltage command values Vu, Vv and Vw, and supply a voltage v to the motor 110, thereby generating the torque τ in the motor 110.

Since there is an error (an installation error, etc.) between the motor angle detected by the angle sensor 110a and an actual angle, such angle error may cause a torque current in the two-phase/three-phase conversion portion 106.

In this regard, in the embodiment of the disclosure, the motor is controlled based on the current command values in a stationary coordinate system during a low-efficiency operation. The angle error of the dq-axes may be eliminated even when vector control is performed, thereby improving control stability.

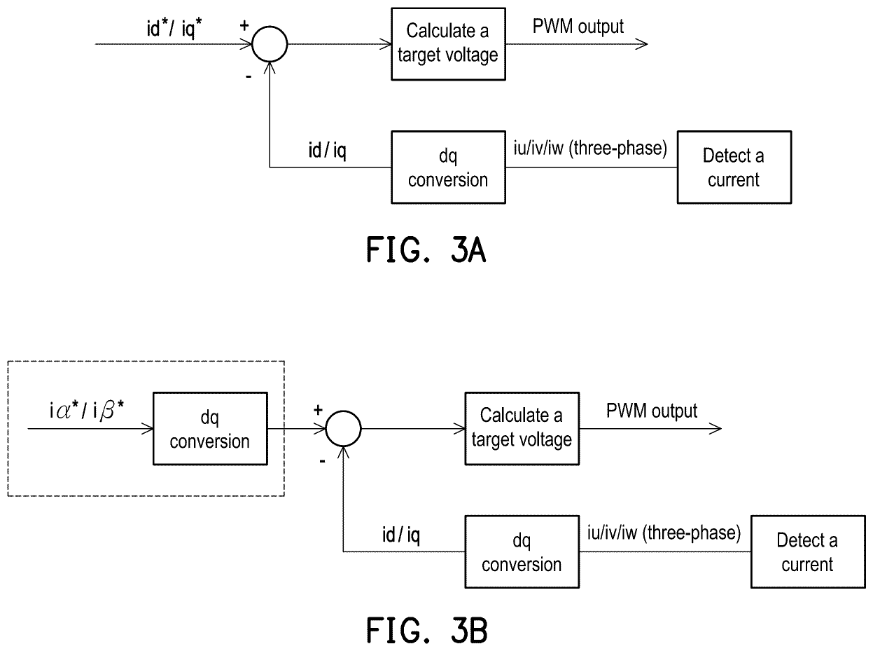

FIG. 3A and FIG. 3B are schematic diagrams of a normal control and a low-efficiency operation control according to an embodiment of the disclosure. Referring to FIG. 3A, according to the embodiment of the disclosure, the motor control device detects the three-phase current signals iu, iv and iw through a current sensor during a normal operation, converts to the direct axis current id and the quadrature axis current iq, and then computes a current deviation between the target current command values id* and iq* and the dq-axes currents id and iq, and performs proportional-integral control on each of the computed current deviations to compute a target voltage and output a pulse-width modulation (PWM) signal, thereby performing vector control based on the dq-axes current command values id* and iq*. The motor control device generates a current command value in a rotating coordinate system during vector control, so the motor may be subject to a control including an angle error.

Referring to FIG. 3B, according to the embodiment of the disclosure, the motor control device controls the motor based on target current command values iα* and iβ* in a stationary coordinate system. That is, the motor control device converts a stationary coordinate system target value (the target current command values iα* and iβ*) generated in the stationary coordinate system) to the rotating coordinate system through dq conversion to determine a rotating coordinate system target value (the target current command values id* and iq*), and then computes a current deviation between the target current command values id* and iq* and the dq-axes currents id and iq, and performs proportional-integral control on each of the computed current deviations to compute a target voltage and output the pulse-width modulation (PWM) signal, thereby performing vector control based on the dq-axes current command values id* and iq*. Thus, even when vector control is performed, the angle error of the dq-axes may be eliminated, thereby improving control stability.

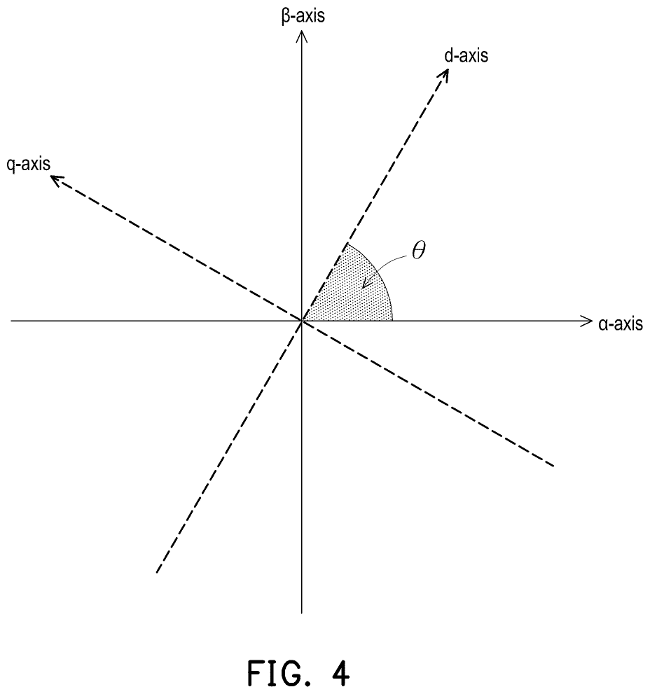

FIG. 4 is a schematic diagram of a rotating coordinate system and a stationary coordinate system according to an embodiment of the disclosure. Referring to FIG. 4, according to the embodiment of the disclosure, vector control is to place a stationary coordinate system composed of an α-axis and a β-axis on a stator of a motor, and place a rotating coordinate system composed of a d-axis and a q-axis on a rotor. A magnetic flux direction generated by a stator U-phase is defined as the α-axis. A direction perpendicular to the α-axis is the β-axis. A magnetic flux direction generated by a permanent magnet of the rotor is the d-axis. A direction perpendicular to the d-axis is the q-axis. An angle formed between the d-axis and the α-axis is an axis correlation angle θ. A magnitude of the axis correlation angle θ depends on a stop position of the rotor.

In vector control, a motor current is divided into two components: the current id toward the d-axis direction and the current iq toward the q-axis direction. The current id generates a magnetic flux in an opposite direction to the magnetic flux of the permanent magnet. The current iq generates a magnetic flux in a direction perpendicular to the magnetic flux of the permanent magnet. Therefore, a magnitude of a torque is determined by a magnitude of the q-axis current. Accordingly, if the current command value id* of the rotating coordinate system=200 A, and iq*=0 A, when a rotor angle is 60 degrees, the current command value iα* of the stationary coordinate system=−73 A, and iβ*=−128.6 A.

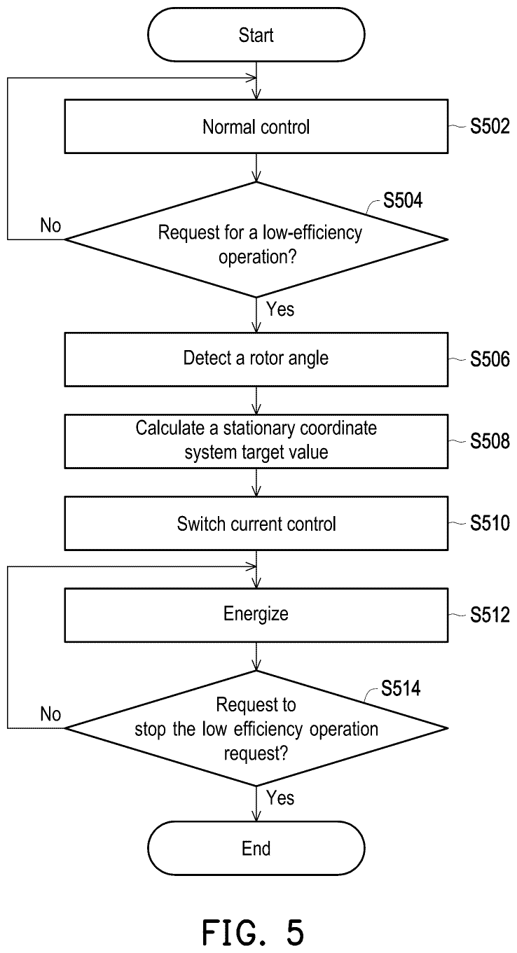

FIG. 5 is a flowchart of a motor control method according to an embodiment of the disclosure. Referring to FIG. 2 and FIG. 5, the motor control method of the embodiment is adapted to the motor control device 100 of FIG. 2. Detailed steps of the motor control method of the embodiment are described below in conjunction with each element in the motor control device 100.

In step S502, a normal control is executed by the motor control device 100. The normal control is, for example, a normal control shown in FIG. 3A. That is, the motor control device 100 determines a rotating coordinate system target value based on a target torque, and determines a stationary coordinate system command value according to the rotating coordinate system target value (that is, the target current command values id* and iq*), and generates a signal to the inverter 130 according to the stationary coordinate system command value.

In step S504, the motor control device 100 determines whether a request to execute a low-efficiency operation is received. If the request for the low-efficiency operation is not received, the process returns to step S502 and continues executing the normal control.

Conversely, if the request for the low-efficiency operation is received, in step S506, the motor control device 100 detects a rotor angle of the motor 110 using the angle sensor 110a. The rotor angle is converted to an electrical angle through the angle sensor 110a and then provided to the three-phase/two-phase conversion portion 103, and is configured to perform a three-phase/two-phase conversion on the three-phase currents iu, iv and iw of the motor 110 detected by a current sensor (not shown), thereby outputting the direct axis current id and the quadrature axis current iq.

In step S508, the current command generation portion 104 of the motor control device 100 computes a stationary coordinate system target value. The current command generation portion 104 computes the stationary coordinate system target value based on a target torque. The stationary coordinate system target value may be converted to a rotating coordinate system to determine the rotating coordinate system target value.

In step S510, the current control portion 105 and the two-phase/three-phase conversion portion 106 of the motor control device 100 executes a switching current control. The current control portion 105 switches a rotating coordinate to a stationary coordinate, which includes determining the stationary coordinate system command value according to the rotating coordinate system target value, and then generating a signal to the inverter 130 by the two-phase/three-phase conversion portion 106 according to the stationary coordinate system command value.

In step S512, the two-phase/three-phase conversion portion 106 of the motor control device 100 energizes the motor to implement the low-efficiency operation, thereby ensuring that the motor does not generate an unnecessary torque when stopped.

In step S514, the motor control device 100 determines whether a request to stop the low-efficiency operation is received. If the request to stop the low-efficiency operation is not received, the process returns to step S512 and continues energizing the motor. Conversely, if the request to stop the low-efficiency operation is received, the operation is ended.

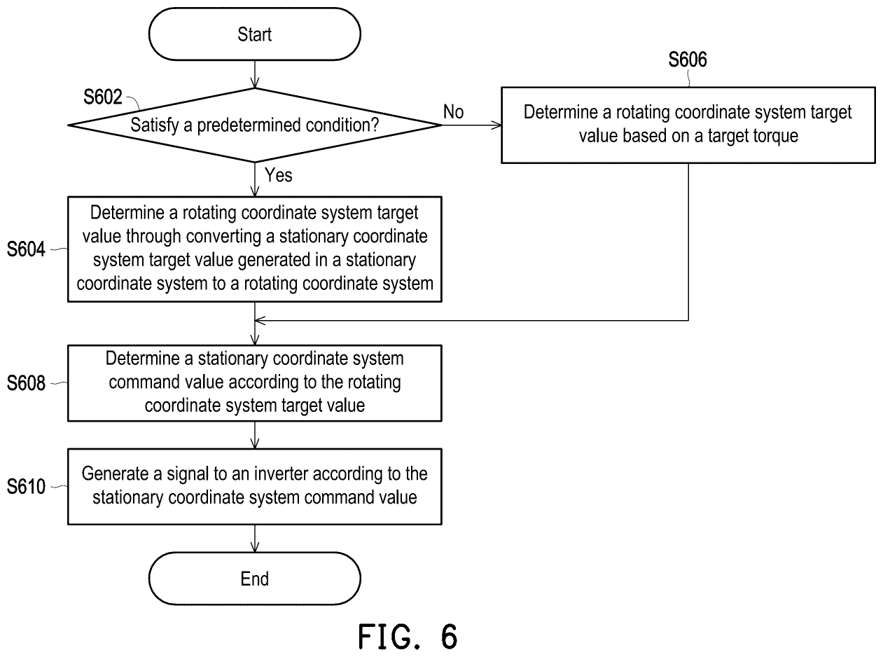

In detail, FIG. 6 is a flowchart of a motor control method according to an embodiment of the disclosure. Referring to FIG. 2 and FIG. 6, the motor control method of the embodiment is adapted to the motor control device 100 of FIG. 2. Detailed steps of the motor control method of the embodiment are described below in conjunction with each element in the motor control device 100.

In step S602, the motor control device 100 determines whether a predetermined condition is satisfied. In some embodiments, the predetermined condition includes selecting a low-efficiency operation.

In some embodiments, if a vehicle includes the foregoing motor 110, the motor control device 100 and a battery, and includes a rotation suppression mechanism configured to suppress a rotation of the motor 110, when the rotation suppression mechanism is initiated, the low-efficiency operation may be executed (satisfying the predetermined condition). The motor control device 100 may further include, for example, a temperature control circuit, which may perform heat transfer between the motor 110 and the battery, and shorten a charging time of the battery through generating heat during the low-efficiency operation and heating the battery through cooling water.

In step S602, if the predetermined condition is satisfied, the current command generation portion 104 of the motor control device 100 determines a rotating coordinate system target value through converting a stationary coordinate system target value generated in a stationary coordinate system to a rotating coordinate system in step S604.

In step S602, if the predetermined condition is not satisfied, in step S606, the current command generation portion 104 of the motor control device 100 determines a rotating coordinate system target value based on a target torque.

In step S608, the current control portion 105 of the motor control device 100 determines a stationary coordinate system command value according to the rotating coordinate system target value.

In step S610, the two-phase/three-phase conversion portion 106 of the motor control device 100 generates a signal to the inverter 130 according to the stationary coordinate system command value.

In the foregoing embodiment, the motor is controlled based on the current command value in the stationary coordinate system. Current flows to a motor winding without generating a torque at a predetermined angle of the motor. Thus, even when vector control is performed, an angle error of the dq-axes may be eliminated, thereby improving control stability.

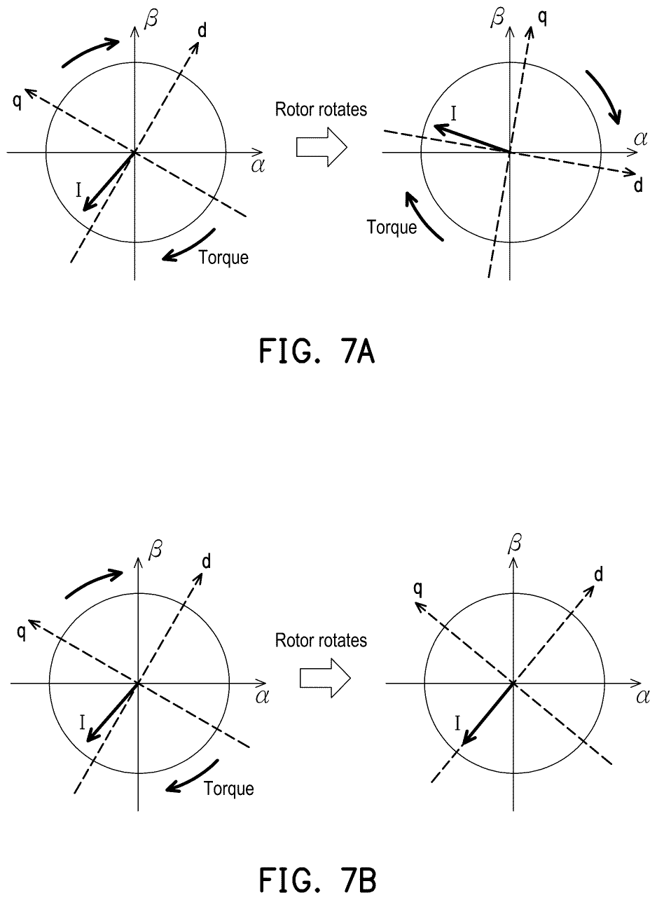

For example, FIG. 7A and FIG. 7B are comparative examples of a motor control method according to an embodiment of the disclosure. Referring to FIG. 7A, a conventional motor control method is to use a rotating coordinate system to determine a current target value, which may generate a torque due to a deviation between a d-axis and a q-axis. Even when a rotor rotates, a current angle deviation remains unchanged and continues to generate the torque. As shown in the figure, an angle deviation between an energizing current I and the d-axis remains unchanged after the rotor rotates.

Referring to FIG. 7B, when the motor control method of the embodiment uses a stationary coordinate system to determine a current target value, although a torque may still be generated in an initial state, since the current is fixed, after the rotor rotates through the error angle, an angle of the energizing current I is the same as the d-axis, therefore no torque is generated at a predetermined angle of the motor (that is, the angle of the energizing current I). At this time, the rotor may stop rotating.

In the foregoing embodiment, when the motor is driven to be energized without rotating, an unexpected torque may be effectively prevented from being generated through switching from a conventional d-axis energizing manner to a current energizing manner at a stationary coordinate.

In some embodiments, in addition to switching the energizing manner to the current energizing manner at the stationary coordinate to prevent the unexpected torque from being generated, the motor control device may further extend an energizing time by reducing temperature rise of a rotor winding.

In detail, the motor control device uses, for example, a temperature sensor to detect and obtain a temperature of a motor winding, and changes a stationary coordinate system target value based on the temperature of the motor winding, so that an energizing angle of the motor is different. The energizing angle is an angle at which current flows to the motor winding without generating a torque.

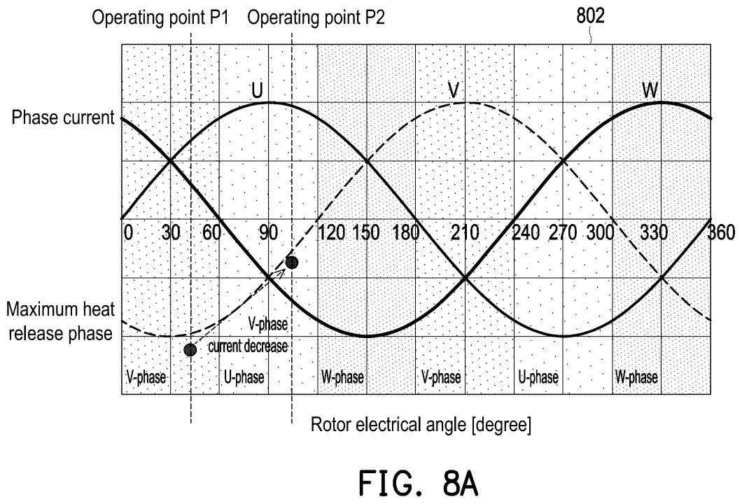

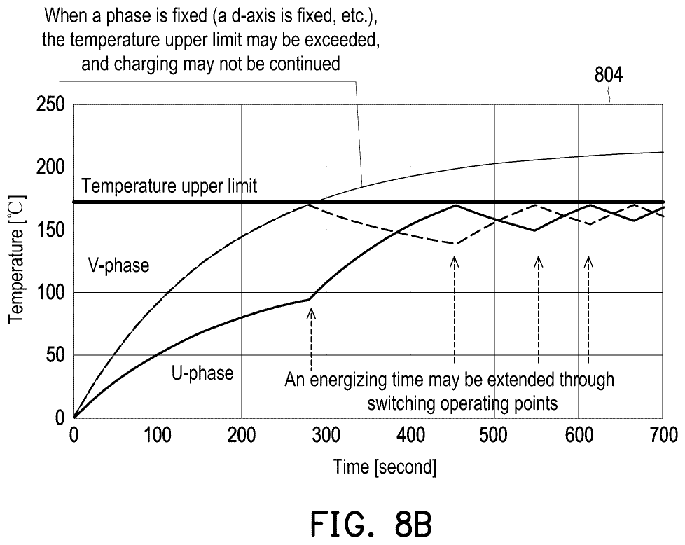

For example, FIG. 8A is a schematic diagram of changes of operating points of a multi-phase motor winding according to an embodiment of the disclosure. FIG. 8B is a schematic diagram of temperature rise of a multi-phase motor windings according to an embodiment of the disclosure. The embodiment suppresses temperature rise of a motor winding through switching angles in a condition where fixed rotor rotation and torque generation are allowed.

In an operating image 802 of FIG. 8A, phase currents of a U-phase winding, a V-phase winding, and a W-phase winding are interactively changed as an electrical angle of a rotor increases. At an operating point P1, a maximum heat release phase is the V-phase. When a temperature of the V-phase winding rises at the operating point P1, through switching to the operating point P2, temperature rise may be reduced, and an energizing time is extended (with a same total loss).

On the other hand, in a temperature rise image 804 of FIG. 8B, through setting a temperature upper limit for the U-phase winding, the V-phase winding, and the W-phase winding in a condition where a phase is fixed (a d-axis is fixed, etc.), when a temperature of the U-phase winding, the V-phase winding, and the W-phase winding exceeds the temperature upper limit, the energization may not be continued. At this time, an energizing time may be extended by switching operating points (the V-phase and the U-phase in the figure).

In some embodiments, a change of the foregoing operating points is determined based on an allowed rotation angle of a rotor or a torque allowed to be generated, and the embodiment is not limited thereto.

In summary, the motor control device and the motor control method according to the embodiments of the disclosure determine the rotating coordinate system target value through converting the stationary coordinate system target value generated in the stationary coordinate system to the rotating coordinate system, determine the stationary coordinate system command value according to the rotating coordinate system target value, and control the motor through generating a signal to the inverter, which can eliminate the angle error of the dq-axes even when vector control is performed, thereby effectively preventing an unexpected torque from being generated and improving control stability. In addition, according to the embodiments of the disclosure, the stationary coordinate system target value is changed based on the temperature of the motor winding, so that the predetermined angle of the motor is different, thereby preventing overheating of a winding of a specific phase and extending an energizing time.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A motor control device, configured to drive an inverter of a motor having a multi-phase motor winding through vector control, comprising:
a control portion, configured to:
determine a stationary coordinate system command value according to a rotating coordinate system target value; and
generate a signal to the inverter according to the stationary coordinate system command value, wherein
when a predetermined condition is satisfied, the rotating coordinate system target value is determined through converting a stationary coordinate system target value generated in a stationary coordinate system to a rotating coordinate system; and
when the predetermined condition is not satisfied, the rotating coordinate system target value is determined based on a target torque.

2. The motor control device according to claim 1, wherein,
the predetermined condition comprises selecting a low-efficiency operation, wherein a current flows to a motor winding without generating a torque at a predetermined angle of the motor.

3. The motor control device according to claim 2, wherein,
the control portion obtains a temperature of the motor winding, and changes the stationary coordinate system target value based on the temperature of the motor winding, so that the predetermined angle of the motor is different.

4. The motor control device according to claim 3, wherein,
a change of an operating point of the motor winding is determined based on an allowed rotation angle of a rotor or a torque allowed to be generated.

5. The motor control device according to claim 2, wherein,
in a vehicle comprising the motor, a battery and the motor control device, the vehicle comprises a rotation suppression mechanism configured to suppress a rotation of the motor, wherein
the control portion executes the low-efficiency operation when the rotation suppression mechanism is initiated.

6. The motor control device according to claim 5, further comprising:
a temperature control circuit, capable of performing heat transfer between the motor and the battery, wherein
the control portion implements the low-efficiency operation based on a temperature of the battery or a temperature of a refrigerant configured to cool the battery.

7. A motor control method, adapted to drive an inverter of a motor having a multi-phase motor winding through vector control, comprising:
determining a stationary coordinate system command value according to a rotating coordinate system target value; and
generating a signal to the inverter according to the stationary coordinate system command value, wherein
determining the rotating coordinate system target value through converting a stationary coordinate system target value generated in a stationary coordinate system to a rotating coordinate system when a predetermined condition is satisfied; and
determining the rotating coordinate system target value based on a target torque when the predetermined condition is not satisfied.

8. The motor control method according to claim 7, wherein,
the predetermined condition comprises selecting a low-efficiency operation, wherein a current flows to a motor winding without generating a torque at a predetermined angle of the motor.

9. The motor control method according to claim 8, further comprising:
obtaining a temperature of the motor winding, and changing the stationary coordinate system target value based on the temperature of the motor winding, so that the predetermined angle of the motor is different.

10. The motor control method according to claim 9, wherein,
a change of an operating point of the motor winding is determined based on an allowed rotation angle of a rotor or a torque allowed to be generated.

11. The motor control method according to claim 8, wherein,
in a vehicle comprising the motor, a battery and a motor control device, the vehicle comprises a rotation suppression mechanism configured to suppress a rotation of the motor, wherein the method further comprises:
executing the low-efficiency operation when the rotation suppression mechanism is initiated.

12. The motor control method according to claim 11, further comprising:
using a temperature control circuit to perform heat transfer between the motor and the battery, wherein
the low-efficiency operation is implemented based on a temperature of the battery or a temperature of a refrigerant configured to cool the battery.
